(19) United States
(12) Patent Application Publication
(10) Pub. No.: US 2013/0267570 A1
(43) Pub. Date: Oct. 10, 2013

(54) STABLE AND AQUEOUS CONCENTRATED PRESERVATIVE COMPOSITION OF DEHYDROACETIC ACID (DHA) AND METHYLISOTHIAZOLINONE (MIT)

(71) Applicants: Raman Premachandran, Saddle Brook, NJ (US); Najeeb H. Najehakimi, Edison, NJ (US); Karen Winkowski, Springfield, NJ (US); Andrea Wingenfeld, Lauben (DE)

(72) Inventors: Raman Premachandran, Saddle Brook, NJ (US); Najeeb H. Najehakimi, Edison, NJ (US); Karen Winkowski, Springfield, NJ (US); Andrea Wingenfeld, Lauben (DE)

(73) Assignee: ISP Investments Inc., Wilmington, DE (US)

(21) Appl. No.: 13/885,614

(22) PCT Filed: Nov. 18, 2011
(86) PCT No.: PCT/US11/61383

§ 371 Date: Jun. 11, 2013

Related U.S. Application Data
(60) Provisional application No. 61/415,465, filed on Nov. 19, 2010.

(51) Int. Cl. A01N 43/80; A01N 43/16

(52) U.S. Cl. CPC A01N 43/80; A01N 43/16
USPC 514/372

(57) ABSTRACT

An aqueous, stable, highly-concentrated preservative composition comprising (i) about 5 to 50 wt % of a dehydroacetic acid (DHA) or a salt thereof; (ii) about 1 to 20 wt % of a 2-methyl-4-isothiazolin-3-one (MIT); (iii) about 0.1 to 10 wt % of at least one block copolymer; (iv) optionally, about 0.01 to 5.0 wt % of at least one sulfosuccinate surfactant; (v) optionally, about 0.01 to 5.0 wt % of at least one sequestering agent; and (vi) optionally, about 0.01 to 5.0 wt % of one or more additives. Also disclosed is a process for preparing said preservative composition.

### FIELD

The present application relates to a concentrated preservative composition, and more particularly, to an aqueous, color stable, highly-concentrated preservative composition comprising dehydroacetic acid (DHA) and 2-methyl-4-isothiazolin-3-one (MIT).

### BACKGROUND

Preservatives are employed in various non-limiting industrial applications including personal care, household, coatings, metalworking fluids, paper, wood, plastics, disinfection, cosmetics, toiletry, pharmaceuticals, food, beverages, oral care, paints, and water treatment to prevent microbial contamination, of which, the personal care products engage significant amount of preservatives. The personal care products can be applied to the human body for the purpose of cleansing, beautifying, promoting attractiveness or altering its appearance. These personal care products are very sophisticated and diverse in formulation. They often include a variety of natural and synthetic ingredients used to fulfill the aesthetic desires of the customer. Unfortunately, these ingredients also provide pH, moisture, and nutritional conditions that support microbial growth. Due to this potential vulnerability, many personal care products employ natural or synthesized preservatives to prevent spoilage.

Therefore, a preservative can be added to such products at the time of manufacturing in order to protect the product against microbial contamination in the long term. The particular choice of type and level of the preservative is typically made by the formulator based upon a number of factors including, for example, the microbiological requirements of the product, cost, the pH of the product, compatibility with the other formulation ingredients and regulatory restrictions. A guide to the factors used in preservative selection and testing can be found in “Cosmetic and Drug Preservation, Vol. I, Principles and Practice”, published by Marcel Dekker Inc.

To deal with the present stringent requirements for preservatives in the personal care sector, attempts have been made to prepare emulsion of preservative composition comprising (i) highly concentrated dehydroacetic acid (DHA), or salts thereof; (ii) at least one isothiazolinone molecule; and (iii) a sequestering agent is; unfortunately, such compositions are unstable and tend to form a brown coloration even on storage at room temperature. The instability towards color is observed due to the alkaline component of the composition which is essential for solublizing high concentration of DHA. At the same time, the presence of the alkaline component in such preservative composition is detrimental to isothiazolinone molecules and it leads to brown color formation which is unfavorable to the system. Hence, it would be desirable to provide a solution to balance the presence of both the components i.e. high concentration of DHA and an isothiazolinone molecule in an alkaline medium to provide aqueous concentrated preservative composition.

US Patent Application No. 20090227675 to International Specialty Products describes antimicrobial compositions which are active against bacteria, yeast and mold spores. The compositions may be blends of (I) an acrylate/methacrylate copolymer having a hydrophobic network structure and (II) a preservative component comprising (A) an isothiazolinone or (B) phenoxyethanol and either (i) a 1,2-diol or (ii) benzoic acid and dehydroacetic acid.

PCT Publication No. WO2009146800 to Lonza Ltd. discloses a preservative formulation comprising the combination of at least two compounds having bactericidal and/or fungicidal properties, wherein the respective combination is selected from the group consisting of methylisothiazolinone/piroctone olamine; caprylyl glycol/dehydroacetic acid; undecanol/dehydroacetic acid and lauryl alcohol/sorbic acid.

PCT Publication No. WO1996000060 to Procter & Gamble Company discloses a topical composition comprising an active comprising N-acetyl-L-cysteine, a preservative, and a cosmetically acceptable and/or pharmaceutically acceptable carrier. In preferred embodiments of this invention, the preservative is selected from benzyl alcohol, propylparaben, ethylparaben, butylparaben, methylparaben, benzylparaben, isobutylparaben, phenoxyethanol, ethanol, sorbic acid, benzoic acid, methylchloroisothiazolinone, methylisothiazolinone, methyl dibromoglutaronitrile, dehydroacetic acid, o-phenylphenol, sodium bisulfate, dichlorophen; and mixtures and salts of any of the foregoing.

U.S. Pat. No. 7,342,044 to Lonza Inc. discloses a biocidal composition comprising a synergistic mixture of certain quaternary ammonium biocides and one or more ketone acids, aromatic carboxylic acids, salts thereof, or mixtures thereof. Patent describes a preservative formulation comprising a synergistic mixture of: (a) dehydroacetic acid or a salt thereof; (b) a benzethonium salt; (c) salicylic acid or a salt thereof (d) benzoic acid or a salt thereof (e) phenoxyethanol; and (f) benzyl alcohol.

US Patent Application No. 20090123577 to Air Liquide Sante (International) discloses a preservative for compositions having an aqueous phase, said preservative consisting essentially of (a) from 10 to 30% by weight of an organic acid selected from the group consisting of benzoic acid, dehydroacetic acid, undecylenic acid, esters of such acids, salts of such acids, and mixtures thereof; (b) from 40 to 80% by weight of an alcohol selected from the group consisting of benzyl alcohol, 2-phenoxyethanol, a phenoxybutanol and a phenoxypropanol; and (c) from 0.5 to 10% by weight of a poly(hexamethylenebiguanide) salt in which the anion is selected from the group consisting of hydrochloride, acetate, lactate, benzoate, propionate, 4-hydroxybenzoate, sorbate and salicylate.

In view of forgoing facts, clearly, there remains a need for a color-stable, aqueous, highly-concentrated preservative composition of DHA with isothiazolinone. Accordingly, it is an object of the present application to provide an aqueous emulsion composition comprising highly concentrated DHA and an isothiazolinone molecule in an alkaline medium.

It is a further object to provide alternative compositions, preferably aqueous dispersion compositions comprising highly-concentrated DHA and an isothiazolinone.

It is a further object of this application to provide heat and cold stable, transit-stable, storage-stable, dilution-stable, easily flowable aqueous concentrated preservative compositions.

### SUMMARY

The present application relates to an aqueous, stable, highly-concentrated preservative composition comprising (i) about 5 to 50 wt % of a dehydroacetic acid (DHA) or a salt thereof; (ii) about 1 to 20 wt % of a 2-methyl-4-isothiazolin-3-one (MIT); (iii) about 0.1 to 10 wt % of at least one block copolymer; (iv) optionally, about 0.01 to 5.0 wt % of at least one sulfosuccinate surfactant; (v) optionally, about 0.01 to 5.0 wt % of at least one sequestering agent; and (vi) optionally, about 0.01 to 5.0 wt % of one or more additives.

In accordance with certain aspects, a concentrated preservative composition is provided which is capable of withstanding heat and cold exposure, wherein the composition is stable for at least two years at room temperature or stable for at least 5 freeze/thaw cycles when the temperature is cycled from 50° C. to −24° C. in every 24 hours or stable for at least 4 weeks at about 50° C.

Another aspect of the present application is to provide color-stable, decomposition-free aqueous concentrated preservative compositions of DHA and MIT by dispersing them into a polymer-surfactant matrix in presence of suitable sequestering agent and/or an alkaline medium.

In a preferred aspect, a concentrated preservative composition is formulated as an emulsion, microemulsion, nanoemulsion, solution, suspension or dispersion.

Another aspect of the present application is to provide a highly-concentrate aqueous-dispersion or aqueous-microemulsion composition which is dilution-stable, storage-stable, transit-stable, easily-flowable, non-drying and incorporable in numerous industrially applications having a pH of about 3.0 to about 12.0.

In accordance with another aspect of the present application, a block copolymer for use in the preservative composition of this invention is selected from a group consisting of tetra-functional block copolymer comprising at least one polyethyleneoxide (PEO) and polypropyleneoxide (PPO) having a molecular weight of from about 1000 to about 10000.

Another aspect of the present application is to employ a sulfosuccinate surfactant which is capable of forming a complex with a tetra functional block copolymer is selected from a group consisting of sulfosuccinate monoester, sulfosuccinate diester, monoalkyl sulfosuccinate, dialkyl sulfosuccinate or their alkali metal salts.

In accordance with another aspect of the present application, the biocide concentrate composition is capable of inhibiting or killing Candida tropicalis, Candida albicans, Hansenula anomala, Saccharomyces cerevisiae, Torulaspora delbreuckii, Zygosaccharomyces bailii, Zygosaccharomyces rouxii, Bacillus subtilis, Bacillus cereus, Staphylococcus aureus, Staphylococus epidermidis, Escherichia coli, Salmonella typhimurium, Salmonella enteritidis, Vibrio parahaemolyticus, Pseudomonas aeruginosa, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and/or Mucor racemosus.

In yet another aspect, the additives for preparing the desired biocide concentrate composition may be selected from the group consisting of colorants, pigments, wetting agents, suspending agents, thickening agents, emulsifying agent, dispersing agents, pH modifiers, anti-foaming agents, water-miscible solvents, solubilizers alone or in combination.

In still another aspect, the concentrated preservative compositions of the present application is employed in the field of agriculture, health, pharmaceutical, dermatological, food, paint, homecare, personal care, metal working fluids, oilfield, building materials, stucco, concrete, caulks, sealants, joint compounds, adhesives, leather, wood, inks, pigment dispersions, drilling mud, house hold, cleaning, detergent and/or clay slurries.

### DETAILED DESCRIPTION

While this specification concludes with claims particularly pointing out and distinctly claiming that which is regarded as the invention, it is anticipated that the invention can be more readily understood through reading the following detailed description of the invention and study of the included examples.

By the term “comprising” herein is meant that various optional, compatible components can be used in the compositions herein, provided that the important ingredients are present in the suitable form and concentrations. The term “comprising” thus encompasses and includes the more restrictive terms “consisting of” and “consisting essentially of” which can be used to characterize the essential ingredients such as biocide, antioxidant and additives, if any, of the biocide concentrate composition.

All percentages, parts, proportions and ratios as used herein, are by weight of the total composition, unless otherwise specified. All such weights as they pertain to listed ingredients are based on the active level and, therefore, do not include solvents or by-products that may be included in commercially available materials, unless otherwise specified.

All references to singular characteristics or limitations of the present invention shall include the corresponding plural characteristic or limitation, and vice-versa, unless otherwise specified or clearly implied to the contrary by the context in which the reference is made.

Numerical ranges as used herein are intended to include every number and subset of numbers contained within that range, whether specifically disclosed or not. Further, these numerical ranges should be construed as providing support for a claim directed to any number or subset of numbers in that range.

As used herein, the words “preferred,” “preferably” and variants refer to embodiments of the invention that afford certain benefits, under certain circumstances. However, other embodiments may also be preferred, under the same or other circumstances. Furthermore, the recitation of one or more preferred embodiments does not imply that other embodiments are not useful, and is not intended to exclude other embodiments from the scope of the invention.

References herein to “one embodiment,” “one aspect” or “one version” or “one objective” of the invention include one or more such embodiment, aspect, version or objective, unless the context clearly dictates otherwise.

All publications, articles, papers, patents, patent publications, and other references cited herein are hereby incorporated herein in their entireties for all purposes to the extent consistent with the disclosure herein.

The term “biocide” or “antimicrobial” as used herein is to be understood to refer to agents such as germicides, bactericides, fungicides, algicides, aquaticides, herbicide, insecticide, larvicide, pesticide, rodenticide, taeniacide, plant growth regulators and the like, which are used for their ability to inhibit growth of and/or destroy biological and/or microbiological species such as bacteria, fungi, algae, caterpillar, insects, larvae, mildew, rodents, spider, worm and the like.

The term “highly concentrated” or “concentrated” means the concentration of active substance is sufficiently high to enable the corresponding aqueous-dispersion or aqueous-microemulsion based concentrated preservative composition of the present application, and wherein the concentration of dehydroacetic acid (DHA) is at least about 45 wt. % of the total composition.

The term “sequestering agent” or “chelating agent” as used in this specification and claims relates to a compound which is capable of bonding or complexing a metal ion between two or more atoms of the compound, thereby neutralizing or controlling harmful effects of such metal ions, wherein holding or bonding of a metal ion is through, a combination of one or more different types of bonds including coordination and/or ionic bonds.

As used, herein, “stable” and “stability” mean a composition which is significantly unaffected in chemical nature, physical homogeneity and/or color upon exposure to conditions reasonably expected to be incurred in transport, storage and use. Stability may be determined either by empirical observation or by suitable methods of chemical and/or physical examination that would be known to one skilled in the art.

The term “salt” means an ionic form of DHA, a parent compound or the product of the reaction between DHA with a suitable base to make the base salt DHA. Salts of the compounds of the present application can be synthesized from DHA which contain an acidic moiety by conventional chemical methods. Generally, the salts are prepared by reacting the free acid parent compound with stoichiometric amounts or with an excess of the desired salt-forming inorganic or organic base in a suitable solvent or various combinations of solvents.

The present application describes an aqueous, stable, highly-concentrated preservative composition comprising (i) about 5 to 50 wt % of a dehydroacetic acid (DHA) or a salt thereof; (ii) about 1 to 20 wt % of a 2-methyl-4-isothiazolin-3-one (MIT); (iii) about 0.1 to 10 wt % of at least one block copolymer; (iv) optionally, about 0.01 to 5.0 wt % of at least one sulfosuccinate surfactant; (v) optionally, about 0.01 to 5.0 wt % of at least one sequestering agent; and (vi) optionally, about 0.01 to 5.0 wt % of one or more additives.

In a particular embodiment, the high concentration of dehydroacetic acid or a salt is employed as a preservative agent, and wherein said dehydroacetic acid can be in the form of isomers, derivatives and tautomers.

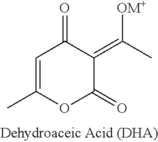

“M+” is a cationic, inorganic/organic basic species, wherein the inorganic bases would include ammonia or hydroxide, carbonate, or bicarbonate of ammonium or a metal cation that does not exhibit any unnecessary toxicity such as sodium, potassium, lithium, calcium, magnesium, iron, zinc, copper, manganese, aluminum, and the like. Particularly preferred metal cations are ammonium, potassium, sodium, calcium, and magnesium salts. Further, the organic nontoxic bases include salts of primary, secondary, and tertiary amines, quaternary amine compounds, substituted amines including naturally occurring substituted amines, cyclic amines and basic ion-exchange resins, such as methylamine, dimethylamine, trimethylamine, ethylamine, diethylamine, triethylamine, isopropylamine, tripropylamine, tributylamine, ethanolamine, diethanolamine, 2-dimethylaminoethanol, 2-diethylaminoethanol, dicyclohexylamine, lysine, arginine, histidine, caffeine, hydrabamine, choline, betaine, ethylenediamine, glucosamine, methylglucamine, theobromine, purines, piperazine, piperidine, N-ethylpiperidine, tetramethylammonium compounds, tetraethylammonium compounds, pyridine, N,N-dimethylaniline, N-methylpiperidine, N-methylmorpholine, dicyclohexylamine, dibenzylamine, N,N-dibenzylphenethylamine, 1-ephenamine, N,N′-dibenzylethylenediamine and/or polyamine resins. Particularly preferred inorganic or organic nontoxic bases of the present application are sodium, potassium, triethanolamine, isopropylamine, diethylamine, ethanolamine, trimethylamine, dicyclohexylamine, choline, and/or caffeine.

The dehydroacetic acid (DHA) required for the preparation of highly concentrated preservative composition is the range of about 5% to about 50% by weight of the composition. The aqueous-dispersion compositions of the present application comprise from about 30.0% to about 50% by weight of the composition, preferably from about 40% to about 45%, more preferably from about 42% to about 45% of dehydroacetic acid or their acceptable salts, derivatives, isomers or tautomers thereof. The aqueous-microemulsion compositions of the present application comprise from about 5% to about 20% by weight of the composition, preferably from about 8% to about 12%.

The suitable biocide employed along with dehydroacetic acid (DHA) to prepare the concentrated preservative composition is selected from isothiazolinone based molecules; the preferred isothiazoliones would include but are not limited to N-butyl-1,2-benzisothiazolin-3-one (BBIT), 4,5-dichloro-n-octyl-4-isothiazolin-3-one (DCOIT), 2-methyl-4-isothiazolin-3-one (MIT), 1,2-Benzisothiazolin-3-one (BIT), 2-Octyl-4-isothiazolin-3-one (OIT), 5-Chloro-2-methyl-4-isothiazolin-3-one (CMIT). The most preferred isothiazolinone is 2-methylisothiazolin-3-one (MIT). The isomers, salts, derivatives or the tautomers of abovementioned biocides may also be considered.

The 2-methylisothiazolin-3-one (MIT) required for the preparation of highly concentrated preservative composition is present in the range of about 1% to about 20% by weight of the composition. The aqueous-dispersion of concentrated preservative composition comprises from about 8% to about 12%, more preferably from about 8% to about 10% of MIT or their isomers. Aqueous-microemulsion compositions of the present application comprise from about 2% to about 10% by weight of the composition, preferably from about 2% to about 6%.

The highly concentrated aqueous composition of DHA plus an isothiazolinone molecule is achieved through polymer-surfactant interaction/complexation technology. The polymer-surfactant matrix is in the form of a complex that stabilizes the hydrophobic water-immiscible or water-insoluble preservative or antimicrobial agent present in the micro-emulsion, and wherein, the hydrophobic preservative compound is present as micro/nano particles. In accordance with certain embodiments of the present application, the compositions exhibit visual clarity and can be diluted to form use compositions of various concentrations of the preservative compositions. The term “complex” is used broadly to refer to a polymer-surfactant combination wherein the surfactant and polymer interact to provide a lower surface tension than either one of the components alone. Although not wishing to be bound by theory, it is theorized that the polymer-surfactant complex functions to stabilize any hydrophobic material in the composition. The stable nano or microemulsion can provide a solvent-free or reduced solvent system for delivering the antimicrobial preservative compositions.

According to one important embodiment of the present application, it employs nonionic surfactants such as polyoxyethylene (EO)/polyoxypropylene (PO) block copolymer (EO/PO block copolymer) for the preparation of highly concentrated aqueous preservative compositions and wherein the selected EO/PO block copolymers is difunctional diblock copolymer, triblock copolymers, tetrablock or higher block copolymers preferably having the following generic structures I, II, III, IV or V.

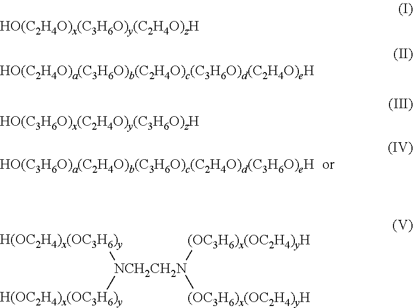

wherein x, y, z, a, b, c, d and e are integers having their value between 1 to about 250. The value of integers of block copolymer is designed such that the molecular weight of the resulting copolymer is in the range of about 1000 to about 100000.

Another preferred class of block copolymers useful herein includes tetrafunctional block copolymers derived from sequential addition of ethylene oxide and propylene oxide to ethylene diamine. These polymers, in an unsulfated form, are commercially available as Tetronics®. Another preferred class of block copolymer contains at least one polyethylene oxide (PEO) block as the hydrophilic portion of the molecule and at least one polybutylene oxide (PBO) block as the hydrophobic portion. Particularly preferred block copolymers of this class are diblock, triblock, and higher block copolymers of ethylene oxide and butylene oxide, such as are represented, for example, by the following structural formula VI to VIII:

PEOPBO VI

PEOPBOPEO VII

PEOPBOPEOPBOVIII

The block copolymers useful herein are known compounds and/or can be readily prepared by techniques well known in the art.

The commercially available block copolymers would include but are not limited to PLURONIC® P103, PLURONIC® L 101, PLURONIC® P65, PLURONIC®-P108, PLURONIC®-R25R2, PLURONIC®-R31R1, WITCONOL®-NS500LQ, PLURONIC®-L31, PLURONIC®-L35, PLURONIC®-F127, PLURONIC®-F108, PLURONIC®-F88, PLURONIC®-F87, PLURONIC®-P85, PLURONIC®-L72, PLURONIC®68, PLURONIC®F77, PLURONIC®25R1, PLURONIC®25R8, PLURONIC®L62D, PLURONIC®72, TETRONIC® 1107, TETRONIC®1301, TETRONIC®1304, TETRONIC®150R1, TETRONIC®304, TETRONIC®701, TETRONIC®901, TETRONIC®904, TETRONIC®908, TETRONIC® 90R4, TETRONIC®808, TETRONIC®50R4, TETRONIC®70R2, TETRONIC®70R4, TETRONIC®90R4, TETRONIC®90R8, TETRONIC®150R4, TETRONIC®150R8, TETRONIC®70R1, TETRONIC®90R1, TETRONIC®110R1, TETRONIC®130R1, and/or TETRONIC®1502.

Alternatively, the various other possible useful nonionic surfactants for preparing aqueous preservative composition of the present application would include, but are not limited to, polyoxyethylene alkyl ethers, polyoxyethylene alkylaryl ethers, polyoxyethylene alkylaryl ether/formaldehyde condensates, polyoxyalkylene aryl ethers, polyoxyalkylene alkyl esters, polyoxyalkylene alkyl sorbitol esters, polyoxyalkylene sorbitan esters, polyoxyalkylene alkyl glycerol esters, polyoxyalkylene block copolymer alkylglycerol esters, polyoxyalkylene alkyl sulfonamides, polyoxyalkylene rosin esters, polyoxypropylene block copolymers, polyoxyethylene oleyl ethers, polyoxyalkylene alkylphenols and mixtures consisting of two or more of these compounds.

A variety of classes of preferred surfactants, appropriate for practice of the present composition have been described by Schmolka in “Non-Ionic Surfactants,” Surfactant Science Series Vol. 2, Schick, M. J., Ed. Marcel Dekker, Inc., New York, 1967, Chapter 10 which is incorporated herein by reference.

These block copolymer are used in range of 0.01 to about 10% by weight, preferably used in range of 0.1 to 3% by weight and most preferably used in range of about 0.1 to 2% by weight based on the total aqueous concentrated preservative compositions.

Accordingly, in preferred embodiments of the present application, sulfosuccinate based anionic surfactants are employed for the preparation of highly concentrated aqueous preservative compositions. The sulfosuccinate type surfactants are mild surfactants amongst all the anionic surfactants and they are similar to alkyl sulfonates. Sulfosuccinate surfactants are of great interest because of their excellent properties such as foaming, strong wetting, emulsifying and solublizing properties, extraordinary surface activity, and effective reduction of surface tension, biodegradability, extreme mildness and low critical micelle concentration (CMC). The suitable sulfosuccinate surfactant is selected from the group consisting of sulfosuccinate monoester, sulfosuccinate diester, monoalkyl sulfosuccinate, dialkyl sulfosuccinate, alkylaryl sulfosuccinate, alkylcycloalkyl sulfosuccinate or their alkali metal salts. The preferred sulfosuccinate surfactants are selected from the group including but are not limited to lauryl sulfosuccinate, laureth sulfosuccinate, laureth-5 sulfosuccinate, ricinoleamide MEA sulfosuccinate, undecyleneamide MEA sulfosuccinate, diisobutyl sulfosuccinate, dioctyl sulfosuccinate, dihexyl sulfosuccinate, dicyclohexyl sulfosuccinate, diisodecyl sulfosuccinate, diisotridecyl sulfosuccinate, di-2-ethylhexyl sulfosuccinate, di-2-methylamyl sulfosuccinate, dimethylamyl sulfosuccinate, dibutylhexyl sulfosuccinate, diisooctyl sulfosuccinate or their alkali metal salts alone or in combination.

The commercially available sulfosuccinate based surface active agents would include, but are not limited to AEROSOL OT, AEROSOL EF800, AEROSOL MA80, AEROSOL OT 100, AEROSOL IB-45, MACKANATE DC-50, SOLE TERGE-8, AEROSOL 18, AEROSOL 22, AEROSOL A102, AEROSOL OT-75, AEROSOL OT70-PG, AEROSOL OTS, AEROSOL TR70, AEROSOL GPG, AEROSOL AY, AEROSOL 1B, NEKAL WS25, AEROSOL A196, HOSTAPUR®, HOSTAPUR® SAS, ALKASURF®, ALKASURF SS-MA-80, ALKASURF SS-NO, ALKASURF SS-O, ALKASURF SS-OA-HE, ALKASURF SS-TA, ALKASURF SS-L7DE, ALKASURF SS-L9ME, ALKASURF SS-L-HE, MACKANATE®, MACKANATE CM, MACKANATE CM-100, MACKANATE CP, MACKANATE DOS 70M5, MACKANATE DOS-75, MACKANATE EL, MACKANATE L, MACKANATE LM-40, MACKANATE LO, MACKANATE OD-2, MACKANATE OM, MACKANATE OP, and/or MACKANATE TDS. These surface active agents are preferably used in range of 0.01 to 10% by weight, particularly 0.1 to 3% by weight, based on the total aqueous concentrated preservative dispersion composition.

The suitable organic or inorganic sequestering or chelating agent is selected from the group comprising polyols, gluconates, sorbitals, mannitols, carbonates, hydroxamates, catechols, α-amino carboxylates, alkanolamines, metal-ion sequestrants, hydroxy-carboxylic acids, aminocarboxylic acids, amino polycarboxylic acids, polyamines, polyphosphates, phosphonic acids, crown ethers, amino acids, polycarboxylic acids, cyclodextrin, phosphonates, polyacrylates or polymeric polycarboxylates, condensed phosphates, However, the particular sequestering or chelating agents would include but are not limited to acetic acid, adenine, adipic acid, ADP, alanine, alanine, albumin, arginine, ascorbic acid, asparagine, aspartic acid, ATP, benzoic acid, n-butyric acid, casein, citraconic acid, citric acid, cysteine, dehydracetic acid, desferri-ferrichrysin, desferri-ferrichrome, desferri-ferrioxamin E, 3,4-dihydroxybenzoic acid, diethylenetriaminepentaacetic acid (DTPA), hydroxylpropylenediaminetetraacetic acid (DPTA), dimethylglyoxime, dimethylpurpurogallin, EDTA, formic acid, fumaric acid, globulin, gluconic acid and its alkali metal salts, glutamic acid, glutaric acid, glycine, glycolic acid, glycylglycine, glycylsarcosine, guanosine, histamine, salicylic, pimalic and sulfamic acid, salicylic, glutaric, malonic acid, 1,10-phenanthroline, 2-pyridylacetic acid, 5-formylfuran sulfonic acid, N-tris(hydroxymethyl)methyl-2-aminoethanesulfonic acid, itaconic acid, chelidonic acid, 3-methyl-1,2-cyclopentanedione, glycolamide, histidine, 3-hydroxyflavone, inosine, iron-free ferrichrome, isovaleric acid, itaconic acid, kojic acid, lactic acid, leucine, lysine, maleic acid, malic acid, methionine, methylsalicylate, nitrilotriacetic acid (NTA), ornithine, orthophosphate, oxalic acid, oxystearin, phenylalanine, phosphoric acid, phytate, pimelic acid, pivalic acid, polyphosphate, proline, propionic acid, purine, pyrophosphate, pyruvic acid, riboflavin, salicylaldehyde, salicyclic acid, sarcosine, serine, sorbitol, succinic acid, tartaric acid, tetrametaphosphate, thiosulfate, threonine, trimetaphosphate, triphosphate, tryptophan, uridine diphosphate, uridine triphosphate, n-valeric acid, valine, xanthosine, triethylenetetraaminehexaacetic acid, N,N′-bis(o-hydroxybenzyl)ethylenediamine-N,N′ diacteic acid, ethylenebis-N,N′-(2-o-hydroxyphenyl)glycine, acetohydroxamic acid, desferroxamine-B, disulfocatechol, dimethyl-2,3-dihydroxybenzamide, mesitylene catecholamide (MECAM), 1,8-dihydroxynaphthalene-3,6-sulfonic acid, and 2,3-dihydroxynaphthalene-6-sulfonic acid, siderophores molecules, N,N-dicarboxymethyl-2-aminopentanedioic-acid, diethylenetriaminepentaacetic-acid, ethylene-diaminetetraacetates, nitriloacetates or N-(2-hydroxyethyl)nitrilodiacetates), 2,2-dichloropropionic acid, 2,2-dibromobutyric acid, trifluoroacetic acid, tribromoacetic acid, trichloroacetic acid, 2,3-dibromopropionic acid, 2,2-dichlorovaleric acid, 3-nitropropionic acid, triiodoacetic acid, 3(2,2,2-trichloroethoxy)propionic acid, 4-nitro-2-chlorobutyric acid, 2-bromo-2-nitropropionic acid, 2-nitroacetic acid, 2,4-dihydroxyphenyl acetic acid, 2,4-dichlorophenyl acetic acid, 3(2′,4′-dibromophenoxy)propionic acid, 3(3′,5′-dinitrophenoxy)propionic acid, 3-phenyl-2,3-dibromopropionic acid, 3,5-dinitrosalicylic acid, 3 (3′-bromo-4′-nitrophenyl)propionic acid, 3(3′,4′-dihydroxyphenyl)propionic acid alone or in combination. Further information on sequestering and chelating agents is disclosed in T. E. Furia, CRC Handbook of Food Additives, 2″ Edition, pp. 271-294 (1972), and M. S. Peterson and A. M. Johnson (Eds.), Encyclopedia of Food Science, pp. 694-699 (1978) the disclosures of which are incorporated herein by reference in its entirety. The sequestering agent preferably can be used in range of 0.01 to 5.0% by weight, particularly 0.1 to 2% by weight, based on the total aqueous concentrated preservative dispersion composition.

In accordance with another aspect of the present application, the aqueous concentrated preservative composition is capable of inhibiting or killing microorganisms, yeasts, molds or spores that are selected from a group including but are not limited to Candida tropicalis, Candida albicans, Hansenula anomala, Saccharomyces cerevisiae, Torulaspora delbreuckii, Zygosaccharomyces bailii, Zygosaccharomyces rouxii, Bacillus subtilis, Bacillus cereus, Staphylococcus aureus, Staphylococus epidermidis, Escherichia coli, Salmonella typhimurium, Salmonella enteritidis, Vibrio parahaemolyticus, Pseudomonas aeruginosa, Aspergillus niger, Aspergillus flavus, Penicillium islandicum, Penicillium citrinum, Penicillium chrysogenum, Fusarium oxysporum, Fusarium graminearum, Fusarium solani, Alternaria alternata, and/or Mucor racemosus, Penicillium funiculosum, Aureobasidium pullulans, Gliocladium riruns, Rhizopus javanicus, Penicillium notatum, Leuconostoc citreum, and/or Leuconostoc gelidium.

In another embodiment of the present application, the aqueous concentrated preservative composition is stable for at least two years at room temperature or stable for at least about 5 freeze/thaw cycles when the temperature is cycled from 50° C. to −24° C. in every 24 hours or stable for at least 4 weeks at about 50° C.

In order to prepare an aqueous concentrated preservative composition of MIT and DHA, the aqueous medium can be any type of water that is known in the art for this purpose and preferably selected from treated-water, purified-water, distilled water, de-ionized water, double distilled water, triple distilled water, tap water, de-mineralized water, reverse-osmosis water alone or in combination thereof. This added water to the composition is in addition to water found in or with other components of the present application. The water should be suitable for human consumption and the composition should not be substantially detrimentally, affected by the inclusion of the water.

The aqueous concentrated preservative composition of the present application is easily flowable by its own gravity, conventional, mechanical or through any pneumatic pump that are known in the art.

Further, the aqueous concentrated preservative composition of the present application does not dry up on storage or on transit for at least of at least 18 months at room temperature.

The high concentrated dispersion composition is further diluted to about 0.001 wt % to about 10.0 wt %. This diluted solution does not result in sedimentation and remains stable for at least one week.

Typically, the preservative system is present in an amount of about 0.01 to 30% by weight of the product, more particularly from about 0.1-2% by weight of the product, in certain cases, from about 0.5-1.5%.

The compositions described herein may also include various optional additives. Examples of specific additives include, but are not limited to, plasticizers, surfactants, wetting agents, fillers, coloring agents, dispersing agents, thickening agents, rheology modifying agents, thixotropic agents, anti-freezing agents, co-solvents, pH modifying agents, ultraviolet light stabilizers, antioxidants, algaecides, antimicrobial agents, fragrances, buffers, hydrotropes, anti-soil agents, enzymes, suspending agents, emulsifying agent, anti-foaming agents, organic solvents, VOC-free solvents, solubilizers, and/or water-miscible solvents.

The uniform aqueous concentrated preservative composition system is achieved by suitable suspending/thickening agents. Wherein, these suspending agents can be helpful to suspend the components of the composition uniformly without modifying its original properties. For this purpose various hydrocolloid gums employed would include but are not limited to xanthan gum, guar gum, gellan gum, locust bean gum, gum arabic, alginates etc. are used to impart thixotropic properties to the present compositions. In some embodiments, cellulose thickener is employed, which is a polysaccharide having anhydroglucose units are further connected by an oxygen molecule to form a long molecular chains, has the ability to increase the density or viscosity of the dispersion in which it is integrated. Various cellulose thickener employed in the present disclosure would include but are not limited to hydroxypropyl cellulose, hydroxyethyl cellulose, hydroxypropylmethyl cellulose, ethyl hydroxyethyl cellulose, methyl ethyl hydroxyethyl cellulose, hydroxymethyl cellulose, hydroxyethylmethyl cellulose, carboxymethyl cellulose, sodium carboxymethyl cellulose, microcrystalline cellulose, alone or in combinations thereof. Apart from this, hydrophilically modified ethoxylated urethane (HEUR), the hydrophobically modified ethoxylated urethane alkali swellable emulsions (HEURASE) are also optionally employed according to the requirement. Water-soluble gums are described in Encyclopedia of Polymer Science and Engineering, vol. 7, pp. 589-613 (John Wiley & Sons, Inc. N.Y., N.Y. 1987), the disclosure of which is incorporated by reference.

For example, the suitable commercial thickeners such as but are not limited to Xanthan Gum® (Kelzan® from Kelco), Rhodopol® 23 (Rhone Poulenc) or Veegum® (from R.T. Vanderbilt), organic phyllosilicates (Attaclay® Engelhardt), HASE Thickener (RHEOLATE 425), ALCOGUM™ VEP-II (Alco Chemical Corporation), RHEO VIS™ and VISCALEX™ (Ciba Ceigy), UCAR®, ETHOCEL™ or METHOCEL™ (The Dow Chemical Company) and PARAGUM™ 241 (Para-Chem Southern, Inc.), or BERMACOL™ (Akzo Nobel) or AQUALON™ (Hercules) or ACUSOL® (Rohm and Haas). The hydrophobically modified ethoxylated urethane (HEUR) thickeners such as Acrysol RM 1020, Acrysol RM2020 and Acrysol RM5000 available from Rohm and Haas. Various other HEUR thickener would include Borchi Gel 0434, Borchi Gel 0435 and Borchi Gel 0011, Borchi Gel 0620, Borchi Gel 0621, Borchi Gel 0622, Borchi Gel 0625, Borchi Gel 0626, Borchi Gel PW 25, Borchi Gel LW44, Borchi Gel 0024, Borchi Gel WN50S, Borchi Gel L75N, Borchi Gel L76 from Borchers. Acrysol SCT-275, Acrysol RM8, Acrysol RM 825, Acrysol RM 895 (Rohm and Haas), Tafigel PUR 40, Tafigel PUR 41, Tafigel PUR 50, Tafigel PUR 60 Tafigel PUR 61 from Munzig, UCAR DR-73 from Rohm and Haas, Acrysol TT615 available from Rohm and Haas, Aquaflow ALS 400 from Aqualon, and the hydrophobically modified polyacetal polyether Aquaflow NLS 200, Aquaflow NLS 205, and Aquaflow NLS 210 available from Aqualon/Hercules.

The amount of thickener or suspending agent employed in the present high concentrated, aqueous preservative composition would generally fluctuate between about 0.1% to about 5.0% based on the total weight of the composition, more particularly from about 0.1% to about 3.0%. The quantity of thickener will generally be sufficient to impart to the dispersion a viscosity greater than 100 cp, for example from about 150 cp to about 14,000 cp.

The dispersing agents can be selected from standard organic polymeric dispersants that are known in the art for preparing highly concentrated aqueous preservative compositions and suitable dispersing agent would be readily available to a person skilled in the art from the prior-art. However the exceptional dispersing agent would include poly(methylvinyl ether-co-maleic acid) partially neutralized with sodium hydroxide (EasySperse, EaseySperse P20 by ISP, Wayne N.J.) and polymers of acrylic and methacrylic acid, C₁₁-C₁₅ secondary ethoxylated alcohols and diols, PEG-PLGA-PEG copolymers and polyether polyols. Additional examples of suitable dispersants would include sodium silicate, sodium carbonate, lignosulphonic acid salts (e.g. Polyfon, Ufoxane or Marsperse), a sulfonated naphthalene/formaldehyde condensate (e.g. Morwet), a block copolymer with pigment affinic group (e.g. Disperbyck 190), 1,4 bis(2-ethylhexyl)sodiumsulfosuccinate (e.g. Triton GR PG 70), Polyether-polycarbonate sodium salt (e.g. Ethacryl P), maleic acid-olefin co-polymer (e.g. Vultamol NN 4501), ammonium polyacrylate (e.g. Dispex GA 40), C6-C15 secondary alcohol and alkyl aryl sulfonate (e.g. Zetasperse 2300) and alkyl naphthalene sulfonate (e.g. Agnique), henolsulphonic or naphthalenesulphonic acid salts, 2-amino-2-methyl-1-propanol, tri and tetra sodium salts of pyrophosphate and polyphosphate and water-soluble sodium or ammonium salts of polyacrylates, polycarboxylates and polymethacrylates.

Wetting agents for the proposed invention can be selected from acetylene glycol based compounds and/or an acetylene alcohol surface active agent to reduce the surface tension along with block copolymers and sulfosuccinate surfactants. Particularly preferred acetylene glycol group of compounds are 2,4,7,9-tetramethyl-5-decyne-4,7-diol, 3,6-dimethyl-4-octyne-3,6-diol, and 3,5-dimethyl-1-hexyn-3-ol. The commercially available acetylene glycol surface active agents would include but are not limited to Surfynol series 61, 104, 82, 440, 465, 485, TG and CT-111 CT-121, CT-131, CT211 produced by Air Products and Chemicals, Inc., and Olfine series STG and E1010, supplied by Nisshin Chemical Industry Co., Ltd. These surface active agents are preferably used in amounts of 0.01 to 10% by weight, particularly 0.1 to 2% by weight, based on the total aqueous dispersion composition.

The concentrated preservative composition of the proposed invention can optionally include antifoaming agents. About 0.1 wt % to about 5.0 wt % of antifoaming or defoamers are employed to stop any unwanted foam generated while manufacturing highly concentrated aqueous preservative composition of the present application. The preferred antifoaming agent is selected from a group consisting of silicone based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination. The commercially available antifoaming agent would include, but are not limited to, defoamers that are available from DOW CORNING Dow Corning Corporate Center, Midland, Mich., U.S.A. which include: Antifoam FG-10 Emulsion; Antifoam H-10 Emulsion; Antifoam Y-30 Emulsion; 200® Fluid; 544 Antifoam Compound; FS-1265 Fluid; Antifoam 1400 Compound Antifoam 1410 Emulsion; Antifoam 1430 Emulsion; Antifoam 1510-US Emulsion Antifoam 1520-US Emulsion; Antifoam 2200; Antifoam 2210; 7305 Antifoam; Q2-2617 Diesel Antifoam; Q2-2647 Diesel Antifoam; Q2-2677 Diesel Antifoam; Q2-2600 Diesel Antifoam; Antifoam A Compound;. Antifoam AF Emulsion; Antifoam B Emulsion; .Antifoam C Emulsion; 2-3436 ANTIFOAM COMPOUND; 2-3522 ANTIFOAM COMPOUND; 2-3896 ANTIFOAM COMPOUND; 2-3898 ANTIFOAM COMPOUND; 2-3899 ANTIFOAM COMPOUND; 2-3900 ANTIFOAM COMPOUND; 2-3902 ANTIFOAM COMPOUND; 2-3911 ANTIFOAM; 2-3912 ANTIFOAM; 3160 ANTIFOAM COMPOUND; ANTIFOAM 1400; ANTIFOAM 1500; ANTIFOAM A COMPOUND; ANTIFOAM A COMPOUND-FOOD GRADE; Q2-4128 ANTIFOAM. The other suitable defoamers that are available from LUBRIZOL Corporation Wickliffe, Ohio include: Foam Blast® RKAand Foam Blast® RKB defoamers. Defoamers that are available from BYK-Chemie USA Inc. of 524 South Chemy Street, P.O. Box 5670, Wallingford, Conn. 064927651 Website: http://www.bvk-chemie.com include: BYK®-052; BYK®-057; BYK®-066 N; BYK®-088; BYK®-354; BYK®-392; BYK®-031; BYK®-032; BYK®033; BYK®-034; BYK®-035; BYK®-036; BYK®-037; BYK®-038; BYK®-017; BYK®-018; BYK®-019; BYK®020; BYK®-021; BYK®-022; BYK®-023; BYK®-024; BYK®-025; BYK®-028 A; BYK®-044; BYK®-045; BYK®-060 N; BYK°-065; BYK®-066 N; BYK®-067 A; BYK®-070; BYK®-071; BYK®-080 A; BYK®-088; BYK®-094; BYK®-141; BYK®-1610; BYK®-1615; BYK®-1650; BYK®-1660; Byketol®-WS; BYK®-011; BYK®-012; BYK®-051; BYK®-052; BYK®-053; BYK° 055; BYK®-057; BYK®-A 500; BYK®-A 501; and BYK®-A 530 defoamers. Suitable defoamers those are available from Tego Chemie Service GmbH a business unit of the Degussa AG, Tego Chemie Service GmbH, Goldschmidtstr. 100, 45127 Essen, Germany; Degussa Tego Coating and Ink Additives, 1111 South 6th Avenue, P.O. Box 1111, Hopewell, Va. 23838, USA include: TEGO® Foamex 3062, TEGO® Foamex 8050, TEGO® Foamex K 3, TEGO® Foamex 1488, TEGO® Foamex 7447, TEGO® Foamex 800, TEGO® Foamex 805, TEGO® Foamex 808, TEGO® Foamex 815, TEGO® Foamex 822, TEGO® Foamex 825, TEGO® Foamex 845, TEGO® Foamex 1495, TEGO® Foamex 8030, TEGO® Foamex 810, TEGO® Foamex 830, TEGO® Foamex 832, TEGO®Foamex 835, TEGO® Foamex 840, and TEGO® Foamex 842 defoamers. Defoamers that are suitable include those available from Momentive Performance Chemicals, 22 Corporate Woods Boulevard, Albany, N.Y. 12211 USA including SAG-10; SAG-1000AP; SAG-1529; SAG-1538; SAG-1571; SAG-1572; SAG-1575; SAG-2001; SAG-220; SAG-290; SAG-30; SAG-30E; SAG-330; SAG-47; SAG-5440; SAG-7133 and SAG-770.

Further, it is desired to employ one or more solvents selected from the group comprising of glycols, ethers of glycol, esters of glycol, ethylene glycol, propylene glycol, butylene glycol, dipropylene glycol, diethylene glycol, capryl glycol, polyglycol, glycerol, ether or esters of glycerol, diglycerol, triglycerol, tetraglycerol, pentaglycerol, hexaglycerol, cyclic diols, linear or non-cyclic diols, polyglycerols or their derivatives, aliphatic or aromatic alcohols, alkoxyalkanols or aryloxyalkanols having carbon chain length of C₁-C₂₀, alone or in combination. The preferred glycols are ethylene glycol, 1,2-propylene glycol, 1,3-propylene glycol, diethylene glycol, triethylene glycol, tetraethylene glycol, pentaethylene glycol, hexaethylene glycol, heptaethylene glycol, octaethylene glycol, nonaethylene glycol, decaethylene glycol, 3-methyl-1,5-pentanediol, 2,3-dimethyl-2,3-butanediol, 2,4-dimethyl-2-ethyl-hexane-1,3-diol, 2,2-dimethyl-1,3-propanediol, 2-ethyl-2-butyl-1,3-propanediol, 2-ethyl-2-isobutyl-1,3-propanediol, 1,2-butanediol, 1,3-butanediol, 1,4-butanediol, 1,4-pentanediol, 1,5-pentanediol, 1,6-hexanediol, 1,2-octane-diol(caprylyl glycol), 2,2,4-tetra methyl-1,6-hexanediol, thiodiethanol, 1,2-cyclohexanedimethan-ol, 1,3-cyclohexanedimethanol, 1,4-cyclohexanedimethanol, 2,2,4-trimethyl-1,3-pentanediol, 2,2,4-tetramethyl-1,3-cyclobutanediol, p-xylenediol, hydroxypivalyl hydroxypivalate, 1,10-decanediol and/or hydrogenated bisphenol-A. Examples of aryloxyalkanols used according to this application are phenoxyethanol and phenoxypropanols. Preferred phenoxypropanols are 1-phenoxy-2-propanol, 2-phenoxy-1-propanol or mixtures thereof, and 3-phenoxy-1-propanol. Examples of arylalkanols are 3-phenyl-1-propanol, phenethyl alcohol, veratryl alcohol (3,4-dimethoxyphenylmethyl alcohol), benzyl alcohol and 2-methyl-1-phenyl-2-propanol. The oligoalkanol aryl ethers include, for example, phenoxy-di-, -tri- and -oligoethanol and phenoxydi-, -tri- and -oligopropanol. However, the most preferred solvents of the present application are benzyl-alcohol, phenoxyethanol, capryl-glycol, phenylethyl alcohol and/or polyglycerols.

According to one important embodiment of the present application, the pH of the aqueous microemulsion of concentrated preservative compositions is in the range of about 3.0 to about 12.0. The desired pH of the composition can be obtained by employing any suitable inorganic bases such as sodium hydroxide, ammonium hydroxide and potassium hydroxide, or amines such as triethanol amine, diethanol amine or monoethanol amine. Further, acidic agents employed to adjust the pH of the composition would include, but are not limited to, hydrochloric acid, acetic acid, salicylic acid, citric acid, sulfamic acid alone or in combination. Some non-limiting examples of suitable buffers include phosphates, pyrophosphate and its salts, metaphosphate and its salts, carbonic acid and its salts, hydroxylammonium, adidic acid and its salts, maleic acid and its salts, and ascorbic acid and its salts.

The following is a representative list of some of the numerous possible industrial applications of the present concentrated preservative composition. It should be understood that this list is presented for illustrative purposes only and does not represent any limitation as to possible applications.

(i) Cosmetic products: sunscreens; suntan lotions; after-sun gels, lotions and creams; antiperspirants; deodorants (solutions, powders, gels, roll-ons, sticks, sprays, pastes, creams, lotions); cleansing creams; skin conditioners; skin moisturizers; protectants; skin aging products; skin wrinkle reduction products; products for treatment of acne; products for treatment of rosacea; age-spot reduction products; stretch-mark reduction products; pimple treatment products, skin soothing products; skin infection and lesion treatment products; skin-redness reduction products; stretch-mark reduction products; varicose and spider-vein reduction products; lotions; oils; hand/body creams; shaving gels/creams; body washes; liquid and solid soaps; blood microcirculation improvement products, cellulite reduction products, body toning products, skin penetration enhancers; skin whitening products; cosmetics; shampoos; shower gels; bubble baths; hair treatment products, e.g., medicated shampoos, mousses, waxes, conditioners, styling agents, lotions, pomades, spray gels, hair dyes and tints, colorant and non-colorant rinses, detangling lotions, hair curling and hair straightening products, hair wave products, etc.; hand (or mechanical) dishwashing compositions; hand sanitizers; and disinfectants; lipsticks and lip balms; salves; collodion; impregnated patches and strips for skin treatment; skin surface implants; impregnated or coated diapers; and the like.

(ii) Dental care: mouthwash; dentifrice; dental floss coated and/or impregnated with the composition; protective coating for teeth; toothbrush bristles coated and/or impregnated with the composition; orthodontic appliance coated and/or impregnated with the composition; orthodontic appliance adhesive; denture appliance coated and/or impregnated with the composition; denture appliance adhesive; endodontic composition coated and/or impregnated with the composition; composite-type dental restorative materials; dental cement; dental liner; dental bonding agent; and the like.

(iii) Foods and food products: food-stuffs; animal feed-stuffs; grains; breads; bakery products; confectionary; potato products; pasta products; salads; soups; seasonings; condiments; syrups; jams, jellies and marmalades; dairy products; egg-based products; meats and meat-based products; poultry and poultry-based products; fish and fish-based products; crustaceans and crustacean-based products; fresh and dried fruit products; vegetables and vegetable products; greens; salads; sauces; beverages, e.g., wines, tea extracts, beers, juices; and the like.

(iv) Plastics and miscellaneous products, coated and/or impregnated with the composition, including: medical items, e.g., thermometers, catheters, surgical sutures, blood lines, implants, bandages, surgical dressings, surgical apparel, respirators, etc.; food packaging; drug and cosmetic packaging; eating utensils; shower curtains; bath mats; sponges; mops; toilet seats, rubber gloves; contact lenses; hearing aids; shelving paper; carpet pads; pool covers; animal bedding and cat litter; computer covers and computer keys; doorknobs; tampons and sanitary napkins; dental chairs; dryer sheets; dishcloths; paints and coatings; powdered, liquid, gel and spray cleaners for floors sinks, counter-tops, walls, tiles, floors, carpets; deodorizing liquids, solids, sprays, gels and powders; filters; foams; hair brushes; combs; diaper rash preventer; plasma bag treatment; disposable glove treatment; additive to pasteurized cow milk; additive to blood sample tubes to inactivate HIV, HCMV, and other viruses (safety measure for lab technicians and healthcare providers); additives for condoms, band-aids, or bandages; additive for paint; or animal or plant treatment for microbial infections; and the like.

(v) Fibers and fabrics coated and/or impregnated with the composition, including natural and synthetic fibers and fabrics manufactured from such fibers; wipes, cloths; surgical gauze; crib covers; bassinet covers; bed linens; towels and wash cloths; tents; draw sheets; cubicle curtains; shower curtains; wall coverings; wood and wood products; hospital clothing such as examination robes, physicians' coats, nurses uniforms, etc.; apparel; paper, non-woven fabric, knitted fabric, woven fabric, brick, stone, plastic, polymer, latex, metal, tile, walls, floors, gurneys, tables, or trays; shoes and the like.

(vi) Industrial products: Agricultural sector, pesticide preparations, polymer dispersions, adhesives, thickeners, paints, coatings, pigment dispersions, photographic materials.

(vi) Cleaning and disinfecting: It is contemplated that the preservative composition of the present application is useful for cleaning, disinfecting or inhibiting microbial growth on any hard surface. Examples of surfaces, which may be contacted with the composition of the invention are surfaces of process equipment used e.g. dairies, chemical or pharmaceutical process plants, water sanitation systems, oil processing plants, paper pulp processing plants, water treatment plants, and cooling towers. Additionally, the preservative composition be used for cleaning surfaces and cooking utensils in food processing plants and in any area in which food is prepared or served such as hospitals, nursing homes, restaurants, especially fast food restaurants, delicatessens and the like. It may also be used as a preservation agent or a disinfection agent in water based paints, microbial control of water lines, and for disinfection of water, in particular for disinfection of industrial water.

Another embodiment of the present application is to provide a process for preparing an aqueous, stable, highly-concentrated preservative composition comprising the steps of (i) preparing a homogenous mixture of 2-methyl-4-isothiazolin-3-one (MIT), block copolymer, sulfosuccinate, optional ingredients and additives if any by thoroughly mixing in a grinder without zirconium beads for at least 15 minutes; (ii) adding a dehydroacetic acid (DHA) or salt thereof to a mixture of step (i); (iii) grinding the combined resultant mixture of step (ii) with zirconium beads for at least 20 minutes to result in Hegmann value of about 6 to 7; and (iv) optionally, adding an antifoaming agent.

The grinding or milling media for the preparation of homogenous mixture of concentrated preservative composition is selected from steel shots, carbon steel shots, stannous steel shots, chrome steel shots, tungsten carbide, silicon nitride, silicon, carbide, ceramic, zirconium based media including zirconia, zirconium silicate, zirconium oxide, stabilized zirconia such as yttrium stabilized zirconia, calcium stabilized zircona, magnesium stabilized zirconia, cerium stabilized zirconia, stabilized magnesium oxide, stabilized aluminum oxide and the like. A particularly preferred grinding media of the present application is zirconium based.

In a preferred embodiment of the present application, the fine particles of components of the composition is obtained through the known comminution methods such as triturating, grinding and/or milling methods in order to achieve the resultant mixture having a particle size of less than about 0.5 μm to about 10.0 μm and preferably about 0.5 mm to about 3.0 μm. Particle size reduction of components of the present composition is carried out preferably in mills, such as, for example, ball mills, agitator ball mills, circulating mills (agitator ball mills with pin grinding system), disk mills, annular chamber mills, double cone mills, triple roll mills and batch mills.

In a preferred embodiment of the present application, a stable and highly-concentrated aqueous dispersion of preservative composition comprises: (i) about 5 to 50 wt % of a dehydroacetic acid (DHA) or a salt thereof; (ii) about 1 to 20 wt % of a 2-methyl-4-isothiazolin-3-one (MIT); (iii) about 0.1 to 10 wt % of at least one block copolymer; (iv) about 0.01 to 5.0 wt % of at least one sulfosuccinate surfactant; (iv) about 0.01 to 5.0 wt % of suspending agent; (v) optionally, about 0.01 to 2.0 wt % of antifoaming agent; and (vi) optionally, about 0.01 to 5.0 wt % of solvent.

According to another preferred embodiment of the present application, a stable and highly-concentrated aqueous microemulsion of preservative composition comprises: (i) about 5 to 15 wt % of a dehydroacetic acid (DHA) or a salt thereof; (ii) about 1 to 10 wt % of a 2-methyl-4-isothiazolin-3-one (MIT); (iii) about 0.1 to 10 wt % of at least one block copolymer; and (iv) about 0.001 to 10 wt % of pH modifying agent; and (v) optionally, about 0.01 to 5.0 wt % of solvent and/or surfactant. The process for preparing said composition comprises mixing components of composition until a clear solution is formed.

Further, certain aspects of the present invention are illustrated in detail by way of the following examples. The examples are given herein for illustration of the invention and are not intended to be limiting thereof.

### Aqueous Dispersion Compositions Comprising Dehydroacetic Acid (DHA, 45%) and Methyl-Isothiazolinone (MIT, 10%)

### Example 1

| Component | Wt. % (in range) |
|---|---|
| Water | 42.70 |
| Dehydroacetic acid (DHA) | 45.00 |
| Methyl-isothiazolinone | 10.00 |
| (MIT, 50% active) | |
| Dispersing Agent | 0.40 |
| HPMC | 0.10 |
| Xanthan gum | 1.10 |
| Alkyl/dialkyl sulfosuccinate | 0.30 |
| Polyglycerol | 1.00 |
| Antifoam | 0.40 |

### Example 2

| Component | Wt. % (in range) |
|---|---|
| Water | 42.20 |
| Dehydroacetic acid (DHA) | 45.00 |
| Methyl-isothiazolinone | 10.00 |
| (MIT, 50% active) | |
| Alkyl/dialkyl sulfosuccinate | 0.40 |
| Xanthan gum | 0.10 |
| Block copolymer | 0.8 |
| Capryl glycol | 1.5 |

### Example 3

| Component | Wt. % (in range) |
|---|---|
| Water | 40.70 |
| Dehydroacetic acid (DHA) | 45.00 |
| Methyl-isothiazolinone | 10.00 |
| (MIT, 50% active) | |
| Alkyl/dialkyl sulfosuccinate | 0.40 |
| Xanthan gum | 0.10 |
| Block copolymer | 0.8 |
| Capryl glycol | 1.5 |
| Phenoxyethanol | 1.5 |

### Aqueous Dispersion Compositions Comprising Dehydroacetic Acid (DHA, 10%) and Methyl-Isothiazolinone (MIT, 2%)

### Example 4

| Component | Wt. % (in range) |
|---|---|
| Water | 84.85 |
| Dehydroacetic acid (DHA) | 10.05 |
| Methyl-isothiazolinone | 4.00 |
| (MIT, 50% active) | |
| Block copolymer | 0.50 |
| Alkyl/dialkyl sulfosuccinate | 0.10 |
| Xanthan gum | 0.50 |

### Example 5

| Component | Wt. % (in range) |
|---|---|
| Water | 82.85 |
| Dehydroacetic acid (DHA) | 10.05 |
| Methyl-isothiazolinone | 4.00 |
| (MIT, 50% active) | |
| Block copolymer | 0.50 |
| Alkyl/dialkyl sulfosuccinate | 0.10 |
| Xanthan gum | 0.50 |
| Capryl glycol | 0.50 |
| Phenoxyethanol | 0.50 |

### Aqueous Microemulsion Compositions Comprising Dehydroacetic Acid (DHA, 10%) and Methyl-Isothiazolinone (MIT, 2%)

### Example 6

| Component | Wt. % (in range) |
|---|---|
| Water | 47.10 |
| Dehydroacetic acid (DHA) | 10.05 |
| Methyl-isothiazolinone | 4.00 |
| (MIT, 50% active) | |
| Block copolymer | 3.50 |
| NaOH (50%) | 4.85 |
| Tween 20 | 30.00 |
| Citric Acid | 0.50 |

### Example 7

| Component | Wt. % (in range) |
|---|---|
| Water | 47.10 |
| Dehydroacetic acid (DHA) | 10.05 |
| Methyl-isothiazolinone | 4.00 |
| (MIT, 50% active) | |
| Block copolymer | 3.50 |
| NaOH (50%) | 4.85 |
| Citric Acid | 0.50 |
| Capryl glycol | 15.00 |
| Phenoxyethanol | 15.00 |

While this invention has been described in detail with reference to certain preferred embodiments, it should be appreciated that the present invention is not limited to those precise embodiments. Rather, in view of the present disclosure, many modifications and variations would present themselves to those skilled in the art without departing from the scope and spirit of this invention.

What is claimed is:

1. An aqueous, stable and highly-concentrated preservative composition comprising:
i. about 5 to 50 wt % of a dehydroacetic acid (DHA) or a salt thereof;
ii. about 1 to 20 wt % of a 2-methyl-4-isothiazolin-3-one (MIT);
iii. about 0.1 to 10 wt % of at least one block copolymer;
iv. optionally, about 0.01 to 5.0 wt % of at least one sulfosuccinate surfactant;
v. optionally, about 0.01 to 5.0 wt % of at least one sequestering agent; and
vi. optionally, about 0.01 to 5.0 wt % of at least one additive

2. The preservative composition according to claim 1, wherein said block copolymer is selected from the group consisting of tetra-functional block copolymer comprising at least one polyethyleneoxide (PEO) and polypropyleneoxide (PPO).

3. The preservative composition according to claim 2, wherein the tetra-functional polyethyleneoxide (PEO) and polypropyleneoxide (PPO) block copolymer has an average molecular weight of from about 1000 to about 100000.

4. The preservative composition according to claim 1, wherein said sulfosuccinate surfactant is selected from the group consisting of sulfosuccinate monoester, sulfosuccinate diester, monoalkyl sulfosuccinate, dialkyl sulfosuccinate or their alkali metal salts.

5. The preservative composition according to claim 1, wherein said sulfosuccinate is selected from the group lauryl sulfosuccinate, laureth sulfosuccinate, laureth-5 sulfosuccinate, ricinoleamide MEA sulfosuccinate, undecyleneamide MEA sulfosuccinate, diisobutyl sulfosuccinate, dioctyl sulfosuccinate, dihexyl sulfosuccinate, dicyclohexyl sulfosuccinate, diisodecyl sulfosuccinate, diisotridecyl sulfosuccinate, di-2-ethylhexyl sulfosuccinate, di-2-methylamyl sulfosuccinate, dimethylamyl sulfosuccinate, dibutylhexyl sulfosuccinate, diisooctyl sulfosuccinate or their alkali metal salts alone or in combination.

6. The preservative composition according to claim 1, wherein said sequestering agent is selected from the group consisting of carboxylic acids, hydroxy-carboxylic acids, aminocarboxylic acids, phosphonic acids, crown ethers, amino acids, ethylene diamine tetraacetic acid, nitrosotrihydroxy-dipropylamine, nitriloacetate, acetyl salicylate and/or gluconic acid salts.

7. The preservative composition according to claim 1, wherein said additive is selected from the group consisting of wetting agents, suspending agents, thickening agents, emulsifying agent, dispersing agents, pH modifiers, anti-foaming agents, water-miscible solvents, solubilizers alone or in combination.

8. The preservative composition according to claim 7, wherein said suspending agent is selected from the group consisting of hydrocolloid gums, cellulose derivatives polysaccharide derivatives, xanthan gum, guar gum, hydroxymethyl cellulose hydroxypropyl methyl cellulose (HPMC), hydroxyproyl ethyl cellulose (HPEC) and/or hydrophobically modified starch to uniformly suspend the finely divided particles.

9. The preservative composition according to claim 7, wherein said pH modifying agents selected from the group consisting of alkali metal hydroxides, amines, inorganic acids, hydrochloric acid, acetic acid, salicylic acid, citric acid, sulfamic acid alone or in combination.

10. The preservative composition according to claim 7, wherein said dispersing agent is selected from the group consisting of copolymer of 2-pyrrolidone and methoxy ethylene sodium salt, polymers of acrylic and methacrylic acids, C₁₁-C₁₅ secondary ethoxylated alcohol, diols sodium silicate, sodium carbonate, lignosulphonic acid salts, C₆-C₁₅ secondary alcohol and alkyl aryl sulfonate and/or polyether polyols or poly (methylvinyl ether-co-maleic acid) partially neutralized with sodium hydroxide.

11. The preservative composition according to claim 7, wherein said antifoaming agent is selected from a group consisting of silicone based compounds, alcohols, glycol ethers, mineral spirits, acetylene diols, polysiloxanes, organosiloxanes, siloxane glycols, reaction products of silicon dioxide and organosiloxane polymer, polydimethylsiloxanes or polyalkylene glycols alone or in combination.

12. The preservative composition according to claim 7, wherein said solvent is selected from the group consisting of glycols, ethers of glycol, esters of glycol, ethylene glycol, propylene glycol, butylene glycol, dipropylene glycol, diethylene glycol, capryl glycol, polyglycol, glycerol, ether or esters of glycerol, diglycerol, triglycerol, tetraglycerol, pentaglycerol, hexaglycerol, cyclic diols, linear or non-cyclic diols, polyglycerols or their derivatives, aliphatic or aromatic alcohols having carbon chain length of C₁-C₂₀, alone or in combination.

13. The preservative composition according to claim 7, wherein said solvent is benzyl-alcohol, phenoxyethanol, capryl-glycol, phenylethyl alcohol and/or polyglycerols.

14. The preservative composition according to claim 1, capable of inhibiting or killing gram (+) and gram (−) bacterial strains, yeasts and mold spores.

15. The preservative composition according to claim 1, capable of inhibiting or killing Candida tropicalis, Candida albicans, Hansenula anomala, Saccharomyces cerevisiae, Torulaspora delbreuckii, Zygosaccharomyces bailii, Zygosaccharomyces rouxii, Bacillus subtilis, Bacillus cereus, Staphylococcus aureus, Staphylococus epidermidis, Escherichia coli, Salmonella typhimurium, Salmonella enteritidis, Vibrio parahaemolyticus, Pseudomonas aeruginosa, Aspergillus niger, Aspergillus flavus, Penicillium islandicum, Penicillium citrinum, Penicillium chrysogenum, Fusarium oxysporum, Fusarium graminearum, Fusarium solani, Alternaria alternate, and/or Mucor racemosus.

16. The preservative composition according to claim 1, wherein the composition is stable for at least two years at room temperature or stable for at least 5 freeze/thaw cycles when the temperature is cycled from 50° C. to −24° C. in every 24 hours or stable for at least 4 weeks at about 50° C.

17. The preservative composition according to claim 1, wherein the composition is easily flowable and does not dry-up on storage of at least 18 months at room temperature.

18. The preservative composition according to claim 1, wherein the concentrate is further diluted to about 0.001 wt % to about 10.0 wt %.

19. The preservative composition according to claim 1 formulated as an emulsion, microemulsion, nanoemulsion, solution, dispersion, suspension or concentrate.

20. The preservative composition according to claim 1 employed in the field of cosmetic, toiletry, personal care, household, cleaning, disinfecting, food, beverages, contact lens, enzyme formulations, food ingredients and laundry products.

21. A process for preparing an aqueous, stable and highly-concentrated preservative composition comprising the steps of:
i. preparing a homogenous mixture of 2-methyl-4-isothiazolin-3-one (MIT), block copolymer, sulfosuccinate, optional ingredients and additives if any by thoroughly mixing in a grinder without zirconium beads for at least 15 minutes;
ii. adding a dehydroacetic acid (DHA) or salt thereof to a mixture of step (i);
iii. grinding the combined resultant mixture of step (ii) with zirconium beads for at least 20 minutes to result in Hegmann value of about 6 to 7; and
iv. optionally, adding an antifoaming agent.

22. A stable and highly-concentrated aqueous dispersion of preservative composition comprising:
i. about 5 to 50 wt % of a dehydroacetic acid (DHA) or a salt thereof;
ii. about 1 to 20 wt % of a 2-methyl-4-isothiazolin-3-one (MIT);
iii. about 0.1 to 10 wt % of at least one block copolymer;
iv. about 0.01 to 5.0 wt % of at least one sulfosuccinate surfactant;
v. about 0.01 to 5.0 wt % of suspending agent;
vi. optionally, about 0.01 to 2.0 wt % of antifoaming agent; and
vii. optionally, about 0.01 to 5.0 wt % of solvent.

23. A stable, aqueous microemulsion of preservative composition comprising:
i. about 5 to 15 wt % of a dehydroacetic acid (DHA) or a salt thereof;
ii. about 1 to 10 wt % of a 2-methyl-4-isothiazolin-3-one (MIT);
iii. about 0.1 to 10 wt % of at least one block copolymer;
iv. about 0.001 to 10 wt % of pH modifying agent; and
v. optionally, about 0.01 to 5.0 wt % of solvent and/or surfactant.
